(19) United States
(12) Patent Application Publication
(10) Pub. No.: US 2011/0209404 A1
(43) Pub. Date: Sep. 1, 2011

(54) PLANT TREATMENT METHOD AND MEANS THEREFOR

(76) Inventor: Lionel Scott, Hinxton (GB)

(21) Appl. No.: 13/009,087

(22) Filed: Jan. 19, 2011

Related U.S. Application Data
(63) Continuation-in-part of application No. 11/698,055, filed on Jan. 26, 2007, now abandoned.

(30) Foreign Application Priority Data
Jan. 26, 2006 (GB) 0601602.6

(51) Int. Cl. A01G 1/00; F25D 27/00

(52) U.S. Cl. 47/58.1 LS; 62/264

(57) ABSTRACT

A method of altering the level of at least one phytochemical in a harvested plant cell comprising chlorophyll or in harvested plant tissue comprising chlorophyll, the plant cell or tissue being capable of photosynthesis and/or being capable of blue light adsorption by shining blue light onto the surface of the plant cell or tissue, wherein the light intensity of the blue light striking the cell surface or the tissue surface is sufficient to initiate a biochemical process within the cell or tissue thereby altering the level of at least one phytochemical therein.

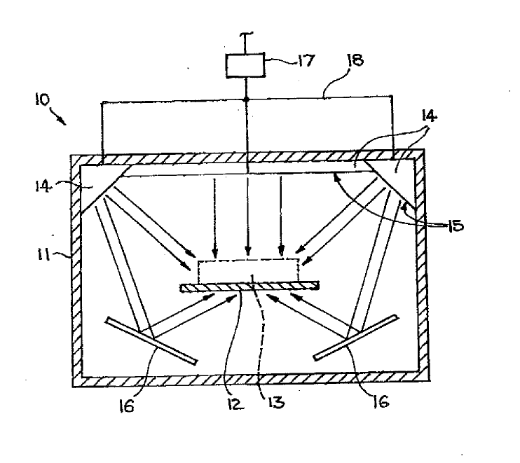

The present invention relates to a method for altering the level of phytochemicals in plant cells and/or plant tissue and means therefor. In particular, the invention relates to a method for altering the level of phytochemicals such as plant primary or secondary metabolites in harvested plant cells and/or plant tissue by applying wavelengths of light of selected wavelength and intensity thereto that are selected from wavelengths of light from the white light or visible spectrum and means therefor.

It is known that the application of light from the UV spectrum, such as UV-B and UV-C can help to increase the levels of for example ‘essential oils’ and secondary metabolites in whole plants. However, UV-B and UV-C is problematic to handle for humans and is heavily implicated in cancerous disease processes. As such, UV-B and UV-C light is considered potentially harmful to healthy mammalian tissue and is considered hazardous to use.

‘Essential oils’ are responsible in large part for the aromaticity associated with many plants, such as plants comprising perfumed flowers and herbs, such as culinary herbs. Essential oils consist mainly of terpenoids and can include such compounds as 1,8-cineole, limonene, linalool and 1-ocimene. Other compounds which may be found in essential oils, that is, oils which are not terpenoids, can include phenyl-propanoid-derived compounds such as methyl chavicol, methyl cinnamate, eugenol, and methyl eugenol. Thus, the term ‘essential oils’ is used in a qualitative sense to encompass compounds as indicated herein which contribute to the aromaticity of plants such as perfumed ornamentals and culinary herbs.

Ultraviolet light (and specifically UV-B) is known to have effects on the levels of secondary compounds of the phenyl-propanoid pathway of plants via action on key regulatory enzymes such as phenylalanine ammonia-lyase (Kuhn, D. N. at al (1984) Proc. Natl. Acad. Sci., USA, 81, 1102-1106) and chalcone synthase (Batschauer, A. et al (1996) The Plant Journal 9, 63-69 and Christie, J. M. and Jenkins, G. I. (1996) The Plant Cell 8, 1555-1567). There are many published reports of UV-B stimulation of phenolic compounds, including surface flavonols and flavonoids (Cuadra, P. and Harborne, J. B. (1996) Zeitschrift für Naturforschung 51c, 671-680 and Cuadra, P. et al (1997) Phytochemistry 45, 1377-1383), anthocyanins (Yatsuhashi, H. et al (1982) Plant Physiology 70, 735-741 and Oelmüller, R. and Mohr, H. (1985). Proc. Natl. Acad. Sci., USA 82, 6124-6128) and betacyanins (Rudat, A. and Goring, H. (1995). J. Expl. Bot. 46, 129-134) and these compounds have been implicated both in plant defense (Chappell, J. and Hahlbrock, K. (1984) Nature 311, 76-78 and Guevara, P. et al (1997) Phyton 60, 137-140) and as protection against UV-light (Lois, R. (1994) Planta 194, 498-503; Ziska, L. H. et al (1992) Am. Jnl. Bot. 79, 863-871 and Fiusello, N. et al (1985) Allionia (Turin) 26, 79-88).

FR 3542567 describes the application of blue and/or red light to certain fruits, typically un-harvested fruits, at night for periods of long duration measured in days. Furthermore, it appears that the effect of such light was also ascertained on leaf discs incubated in a 0.1 mole sucrose solution in an incubator. The object of that invention appears to be to alter anthocyanin concentration in the skins of the fruits to make them appear more attractive to the consumer. There does not appear to be a mention of the actual level of light intensity that strikes the fruit surface, and neither does there appear to be a reference to any relationship between the light source(s) used and how far they should be from the fruit surfaces.

The source light intensity referred to in FR 3542567 is alleged to lie within the range of 1 to 200 microW/cm² (from 100 microEinsteins up to 20,000 microEinsteins), depending on light wavelength used (e.g. blue light at 0.82 microW/cm² (82 Einsteins); red light 1.19 microW/cm² (119 microEinsteins) over a period of 114 hours (leaf discs); e.g. red light at 10 microW/cm² (1000 microEinsteins) and 20 microW/cm² (2000 microEinsteins) on apple trees treated for 30 nights at 15 minutes per night; e.g. blue light and red light at about 100 microW/cm² (10,000 microEinsteins) on apples for 4 hours between 22.00 hrs and 02.00 hrs in the morning).

WO 2004/103060 describes the application of white light enriched with blue to harvested plant material that is capable of photosynthesis. However, that international application does not include a technical teaching to blue light being applied at a particular light intensity to the target plant material surface.

Although observations have been reported on the effects of certain bands of UV light and of infrared light in altering, typically increasing the levels of certain phytochemicals within plant cells, the available art appears to be silent on the effect of shining light from visible spectrum wavelengths of specified light intensity onto the plant cell surface or plant tissue surface.

A recognised problem that is associated with harvested vegetables or harvested vegetable parts is that the levels of plant phytochemicals, such as plant secondary metabolites, starts to decrease almost immediately, post-harvest. For example, as harvested vegetables are processed for freezing and/or canning or are simply placed in refrigerators, such as domestic appliances or simply on open surfaces in a room for short periods for eating later by consumers, they lose much of their nutritional content in terms of the levels of phytochemicals found therein. Such phytochemicals include antioxidants such as vitamins, e.g. vitamins C and/or E, glucosinolates, such as sinigrin, sulphoraphane, 4-methylsulphinylbutyl glucosinolate, and/or 3 methyl-sulphinylpropyl glucosinolate, progoitrin and glucobrassicin, isothiocyanates, indoles (products of glucosinolate hydrolysis), glutathione, carotenoids such as beta-carotene, lycopene, and the xanthophyll carotenoids such as lutein and zeaxanthin, phenolics comprising the flavonoids such as the flavonols (e.g. quercetin, rutin), the flavans/tannins (such as the procyanidins comprising coumarin, proanthocyanidins, catechins, and anthocyanins), flavones (e.g. luteolin from artichokes), phytoestrogens such as coumestans, lignans, resveratrol, isoflavones e.g. genistein, daidzein, and glycitein, and resorcyclic acid lactones, and organosulphur compounds, phytosterols, terpenoids such as carnosol, rosmarinic acid, glycyrrhizin and saponins, and chlorophyll and chlorophyllin, sugars, and other food products such as anthocyanins, vanilla and other fruit and vegetable flavours and texture modifying agents and the like. Research indicates that the antioxidant properties of certain phytochemicals may help protect against the effects of ageing and chronic diseases, such as cancer and cardiovascular disease in mammals, and in particular in humans.

Phytochemicals can thus serve as pharmaceutical compounds per se in mammalian species, such as humans, or pharmaceutically active derivatives can be synthesised from other phytochemicals, such as intermediate compounds therefore, and able to be isolated from plants. Thus, phytochemicals that may be substantially pharmaceutically inactive may find a use in providing intermediates for the synthesis of active agents for the treatment of diseases such as cancers, and/or in pain management of mammals suffering from diseases, such as humans. Phytochemicals known to be useful in the design of and/or provision of pharmaceutically active compounds include vincristine and vinblastine from Catharanthus roseus, taxanes such as those described in U.S. Pat. No. 5,665,576, for example, taxol (paclitaxel), baccatin III, 10-deacetylbaccatin III, 10-deacetyl taxol, xylosyl taxol, 7-epitaxol, 7-epibaccatin III, 10-desacetylcephalomannine, 7-epicephalomannine, taxotere, cephalomannine, xylosyl cephalomannine, taxagifine, 8-benxoyloxy taxagifine, 9-acetyloxy taxusin, 9-hydroxy taxusin, taiwanxam, taxane Ia, taxane Ib, taxane Ic, taxane Id, GMP paclitaxel, 9-dihydro 13-acetylbaccatin III, and 10-deacetyl-7-epitaxol from plants of the family Taxaceae such as plants of the genera Amentotaxus, Austrotaxus, Pseudotaxus, Torreya and Taxus, for example from plants of the genus Taxus, such as T. brevifolia, T. baccata, T.×media (e.g. Taxus media hicksii, Taxus×media Rehder), T. wallichiana, T. Canadensis, T. cuspidata, T. floridiana, T. celebica, and T.×hunnewelliana, T. Canadensis, and tetrahydrocannabinol (THC) and cannabidiol (CBD) from cannabis plants such as Cannabis sativa, Cannabis indica, and Cannabis ruderalis, and other pharmaceuticals such as genistein, diadzein, codeine, morphine, quinine, shikonin, ajmalacine, serpentine and the like.

It has now been observed that by exposing or directing certain wavelengths selected from those making up white light onto harvested plant material such as green plant parts or plant cells comprising chlorophyll the level of phytochemicals therein can be transiently increased. Such phytochemicals include primary and secondary metabolites as described herein and other phytochemicals for use as pharmaceuticals, for example, as alluded to herein. As a consequence, the level of desired plant phytochemicals, such as plant secondary metabolites e.g. antioxidants, can be increased in harvested plant material by the simple application of wavelengths of light for relatively short periods of time selected from those wavelengths or bands found in cold light, that is, visible light.

US 2007/01511149 describes the use of wavelengths of light from the range of wavelengths of 400 nm to 700 nm for altering the level of phytochemicals in harvested plant tissue. There is no teaching within US 2007/01511149 that suggests or describes applying such wavelengths of light under chilling conditions to plant tissue.

U.S. Pat. No. 3,930,335 relates to a method and apparatus for growing higher order plants. There is no suggestion or teaching within U.S. Pat. No. 3,930,335 that the method would be or could be applicable to altering the levels of phytochemicals, such as vitamins, in harvested plant tissue.

According to the present invention there is provided a method of altering the level of at least one phytochemical in a harvested plant cell or in harvested plant tissue, providing one of a harvested plant cell comprising chlorophyll and a harvested plant tissue comprising chlorophyll, the provided cell or tissue being capable of photosynthesis, setting an ambient temperature of the provided cell or tissue to a temperature in the range of −0.5 degrees centigrade to 18 degrees centigrade, exposing a surface of the provided cell or tissue for irradiation by light, irradiating the exposed surface by shining blue light from an artificial source thereof onto the exposed surface while maintaining the set ambient temperature, and setting the intensity of the said light striking the exposed surface so as to influence oxygen evolution at the photosystem II reaction centre of the provided cell or tissue and thereby initiate in the cell or tissue a biochemical process causing alteration of the level of said at least one phytochemical in the cell or tissue.

“Harvested plant tissue” may comprise harvested vegetable matter including cut plant parts such as broccoli florets, green beans, cabbage heads, harvested fruits such as apples, pears and other green or unripe fruits, such as unripe tomatoes, and may include any form of plastid capable of forming a plant phytochemical on application of at least blue light thereto. Examples of such plastids include etioplasts, chloroplasts, and chromoplasts.

It is evident from the prior art discussed herein that there is no teaching that the ambient temperature at which light can be directed onto plant parts to resuscitate, especially, vitamin levels can lie within the range of −0.5 degrees Centigrade to 18 degrees Centigrade. This temperature range represents a cooling or refrigerating temperature at which harvested plant parts (such as lettuce, green peppers and cucumber) would not be expected to respond in the manner shown in the examples hereinafter described, because they are harvested plant parts that are not attached to a root system, i.e. a water uptake system, and would not be expected to photosynthesise efficiently and thus replace vitamins; this lack of expectation is because of an assumption that water availability would be too restricted for the photosynthesis reaction, and hence chemical energy in the form of, for example, ATP would not become available for, inter alia, vitamin synthesis reactions. Moreover, such plant parts are not cold-tolerant and would be expected to senesce quickly. Generally, the colder an ambient temperature, the lower the anticipated rate of photosynthesis, with a concurrent decrease in the amount of available phytochemicals. In view of the fact that harvested plant parts are devoid of major structures for water uptake, i.e. a rooting system, the expectation is that photosynthesis would not occur at a rate allowing formation of plant phytochemicals. It is evident from the mentioned examples, and unexpectedly so, that harvested plant parts from all species tested, including species that are not cold-tolerant, e.g. green peppers, are capable of photosynthesis at very low temperatures, such as 0 degrees Centigrade, and are capable of producing high levels of plant phytochemicals in spite of the absence of water uptake structures. In all controls in these examples it can be seen that both sweetness levels and vitamin C content decreased markedly relative to levels observed in treated harvested (“cut”) produce. Harvested plant parts treated with the specified light and temperature regime may be stored for longer and develop a higher nutritional content than harvested plant parts stored under current conventional storage regimes. As clearly indicated in the examples, the senescence of the harvested plant parts is also significantly slowed down relative to controls. The above-mentioned benefits associated with irradiation by in particular, blue light, in conjunction with an ambient temperature in the −0.5 to 18 degrees C. range are not in any way suggested by the prior art.

The level of blue light intensity that strikes the harvested plant cell or harvested plant tissue surface may be any that effects an alteration in the level of at least one phytochemical within the plant cell or plant tissue. The intensity of blue light striking the harvested plant cell or plant tissue may be at least 5 microEinsteins+/−3 microEinsteins. The level of blue light intensity used in the method of the invention may lie in the range of from 5 microEinsteins+/−3 microEinsteins up to 400 microEinsteins+/−50 microEinsteins; from 5 microEinsteins+/−3 microEinsteins up to 300 microEinsteins+/−50 microEinsteins; from 5 microEinsteins+/−3 microEinsteins up to 200 microEinsteins+/−50 microEinsteins; from 50 microEinsteins+/−10 microEinsteins up to 150 microEinsteins+/−30 microEinsteins; about 100 microEinsteins+/−20 microEinsteins; 200 microEinsteins+/−50 microEinsteins; 250 microEinsteins+/−50 microEinsteins and the like, depending on design. An example of the level of blue light in combination with red light, that is to say wherein the plant material is not exposed to any other light source other than blue and/or red light, is given in the examples hereinafter using refrigeration conditions of 0° C.-1° C., that is to say a temperature that may be used in a typical domestic refrigerator. The process of the invention whether it employs blue light alone or a combination of two wavelengths of light selected from only the red and blue visible spectrum may be employed at any temperature in the range of from −0.5° Centigrade to a higher ambient temperature in which the harvested plant cells remain capable of photosynthetic activity. A suitable temperature range in which the process of the invention may be employed is from −0.5° Centigrade to about 45° Centigrade and in one application of the process of the invention, it can be employed within a chilling temperature range typically found under domestic refrigeration conditions and commercial refrigeration conditions or other cooling conditions, such as from −0.5° Centigrade to 18° Centigrade, and preferably from about 1° Centigrade to about 16° Centigrade, and most preferably from about 1° Centigrade to about 2, 3, 4, 5, 6, 7, 8, 9, 10, 11, 12, 13, 14, 15 or 16° Centigrade. The skilled addressee will also appreciate that the method of the invention may be employed at a temperature in the range of from about +8° Centigrade to about room temperature (+25° Centigrade). Typically, the process of the invention is performed on harvested plant material wherein the ambient relative humidity lies between 60% and 100%, such as 65% RH, 70% RH, 75% RH or 80% RH, The level of blue light intensity at the plant part surface may be augmented with white light from a second light source or where white light is not used, the second light source may provide red light, the combined level of light intensity striking the surface of the plant material from both of said light sources may be in the range of from 40 microEinsteins+/−25 microEinsteins up to 3000 microEinsteins+/−300 microEinsteins or more depending on design. Examples of ranges of combined light red and blue light intensities that may be used in the present invention include 240 microEinsteins+/−100 microEinsteins up to 2000 microEinsteins+/−200 microEinsteins; 300 microEinsteins+/−100 microEinsteins up to 1500 microEinsteins+/−150 microEinsteins; 500 microEinsteins+/−200 microEinsteins; 40 microEinsteins+/−10 microEinsteins up to 100 microEinsteins+/−25 microEinsteins; 15 microEinsteins+/−5 microEinsteins up to 300 microEinsteins+/−50 microEinsteins; 15 microEinsteins+/−5 microEinsteins up to 200 microEinsteins+/−20 microEinsteins; 15 microEinsteins+/−5 microEinsteins up to 150 microEinsteins+/−15 microEinsteins; 40 microEinsteins+/−10 microEinsteins and the like. Naturally, the skilled addressee will appreciate that lower light intensities for red, blue, or red and blue combinations of light of from 30 microEinsteins+/−10 microEinsteins to about 100 microEinsteins+/−25 microEinsteins will be sufficient for use in refrigeration or other under cover applications such as domestic household goods, and the like.

The wavelength of blue light used may be selected from the range of from 410 nm to 490 nm such that the selected wavelength of blue light is, or wavelengths of blue light are, capable of altering the level of phytochemicals found in an harvested plant cell or in harvested plant tissue. Typically, the level of phytochemicals contained within harvested plant material is raised upon exposure to desired wavelengths of light over a suitable time interval and at a suitable light intensity according to the invention. Examples of blue light wavelength ranges and values used in the method of the invention include from 420 nm-480 nm; from 435 nm-465 nm; and 450 nm+/−15 nm. Thus, the skilled addressee will appreciate that the wavelength(s) of blue light used in the present invention on plant material such as harvested vegetables or green leaf matter or green plant cells in culture, such as moss cells e.g. cells of physcomitrella patens, according to the method of the invention, constitute wavelengths of blue light and do not include the violet or higher energy light wavelengths.

Additionally, the harvested plant material may be exposed to blue light from one light source in conjunction with white light (that is to say, light from the visible spectrum) from a second light source. This second source of white light may already be enriched with blue light, such as, in the case of conventional light emitting diodes (LEDs) which emit light having a bias towards blue light emission, and in the case of certain white halogen lights e.g. the General Electric Quartzline EHJ, 250 W, 24V light. The first and/or second light source may also be further enriched with red light of a wavelength that lies in the range of from 600 nm-700 nm. The red light intensity of red light striking the target plant material as described herein typically lies in the range of from 1 to 200 microEinsteins+/−50 microEinsteins. Examples of the red light intensity striking the plant material surface include 5 microEinsteins+/−2 microEinsteins up to 150 microEinsteins+/−50 microEinsteins; 30 microEinsteins+/−5 microEinsteins up to 150 microEinsteins+/−50 microEinsteins; 25 microEinsteins+/−10 microEinsteins up to 100 microEinsteins+/−20 microEinsteins; and the like. The skilled addressee will appreciate that the actual intensity of light to be employed on the plant surface will depend on design and plant material used.

Furthermore, it is to be understood that the light wavelength or wavelengths employed in the present invention are selected from so-called ‘cold light’ wavelengths, that is, the light used in the present invention does not comprise UV wavelengths and does not constitute infrared wavelengths, both forms of which are potentially hazardous to use. In a preferred embodiment, the wavelengths or bands of light used lie in the range of from 420 nm to 490 nm for blue light; 400 nm to 700 nm white light enriched with blue light as herein described; and/or 600 nm to 700 nm for red light or in any combination of light wavelengths therein, depending on design and the phytochemical of interest. Examples of the red wavelength used in the present invention may be selected from a wavelength within the range of from 600 nm to 700 nm; 620 nm to 680 nm; 625 nm to 670 nm; or at about 640 nm+/−15 nm. Red or blue light or a combination of both red and blue light at any given energy ratio may be employed in the method of the invention. For instance, the energy ratio of Blue light:Red light may be selected from within the range of from 10:1 to 1:10, 9:1 to 1:9, 8:1 to 1:8, 7:1 to 1:7, 6:1 to 1:6, and 5:1 to 1:5, such as 5:2 to 2:5, 5:3 to 3:5, or 5:4 to 4:5. Other Blue light:Red light ratios may be selected from within the ranges 4:1 to 1:4, 3:1 to 1:3, 2:1 to 1:2, and 1:1 and any permutation within these ranges depending on design. The actual red, blue or blue:red light or red:blue light energy ratio selected may depend on species, age of plant parts, the phytochemical of interest and design. Typically, one unit of energy for blue light may be about 15 microEinsteins+/−3 microEinsteins and one unit of energy for red light may be about 2 microEinsteins+/−1 microEinsteins. From such approximations the light intensity of red light, or blue light, or blue light:red light ratio shone onto plant material such as leaf surfaces may be made. Naturally, the skilled addressee will appreciate that depending on the plant cells or plant tissue employed, the length of time that the plant cells or tissue is exposed to light of wavelengths outlined herein will alter with design. Suitably, the length of time that plant cells or plant tissue may be exposed to wavelengths used in the present invention for an effect on phytochemical levels to be observed is for a predetermined time interval. The time interval may be selected from a continuous time interval or a pulsed time interval. Typically, the time interval is a pulsed time interval of a predetermined frequency that is spread over a time period that is longer in duration than the said pulsed time interval. The time period can be of any length of duration and can be up to 96 hours or more in duration. When a pulsed time interval is employed, the pulsed time interval may be of any length and may lie, for example in the range of from 1 second up to 120 minutes; 1 minute to 60 minutes; 5 minutes to 40 minutes; 10 to 30 minutes; 10 to 20 minutes; 15 minutes and the like depending on design, plant part species, and requirements. Naturally, the man skilled in the art will appreciate that there will be a time interval between light pulses during which the described light sources will not be shining onto the plant material of interest. Furthermore, the man skilled in the art will appreciate that the said time intervals between separate light pulses may be shorter in duration than the pulsed light interval, of the same duration as the pulsed light interval or of longer duration than the light pulse interval. Typically, the level of phytochemicals is elevated on the application of light to the plant tissue or plant cell culture over short time intervals as alluded to herein.

In a further variant in the operating of the method of the instant invention, the light from the said one or more light sources is shone onto the plant cell or plant tissue surface for a predetermined time interval for a continuous time interval. The continuous time interval can be of any length of time up to 96 hours or more in duration. Examples of continuous time intervals include 168 hours; 144 hours; 96 hours; and 72 hours and the like. Examples of ranges from which continuous intervals may be selected include 30 minutes to 96 hours; 30 minutes to 96 hours; 30 minutes to 48 hours; 30 minutes to 24 hours; 30 minutes to 12 hours; 30 minutes to 8 hours and the like. Naturally, the man skilled in the art will also appreciate that the number of minutes or hours will be selected depending on design, plant species and need.

In a further aspect the invention can be employed on any plant tissue that is capable of responding to exposure to, or irradiation with, wavelengths of light as outlined herein. Preferably, the plant tissue comprises tissue that is capable of photosynthesis and/or blue and red light adsorption. Plant material that can be used in the method of the invention includes all green vegetables and green seeds, e.g. peas, green beans, spinach, snow peas (mange tout) species from the Brassica oleracea such as broccoli, green cabbage, red cabbage, Brussels sprouts, kohlrabi, cauliflower, white cabbage, and the like, and all plant material, such as green plant material, for example, cells comprising chlorophyll, green stems, calyx, leaves, and the like that is able to respond to wavelengths of light as hereinbefore described. Other plant material that may be treated in accordance with methods of the invention may be green material such as green needles derived from non-vegetable sources such as plants of the order Taxaceae as described herein, tea leaves, and of cells grown in plant cell cultures in bioreactors such as moss cells and tissues (e.g. protonema) from physcomitrella patens, and other plant cell cultures e.g. callus cell cultures, cultures of lemnospora species, algae or even somatic embryo clusters and fruits such as tomatoes, apples, grapes, unripe (green) bananas, mangoes, kiwi fruit, pineapples, and the like. Naturally, the man skilled in the art will appreciate that “fruit” is used in the context of the shopper at the supermarket or green grocer.

In a further embodiment, there is provided a method of raising the phytochemical content in live plant cells or plant tissue in an environment by exposing the said plant cells or tissue with light of at least a wavelength selected from light of wavelengths found in cold light from an artificial light source. Naturally, the skilled addressee will appreciate that light as described herein and employed in the instant invention alters the phytochemical profile of a plant cell or plant tissue, such as a harvested tissue lies. Preferably, the combination of light sources includes red light of a wavelength that may be selected from a wavelength within the range of from 600 nm-700 nm, preferably from 620 nm-680 nm, more preferably from 625 nm-670 nm, and generally at about 640 nm+/−15 nm. Red or blue light or a combination of red and blue light, or a combination of red and/or blue light with white light at any selected energy ratio may be employed in the method of the invention. In a preferred embodiment, the said plant cells or plant tissue can be located under cover. ‘Under cover’ means that the cells or tissue is located under cover when exposed, for example, during a food processing step prior to further processing such as freezing or canning or heat treating or cooking as alluded to hereinbelow.

Where advantage is to be gained from heat shocking the harvested plant cells or harvested plant tissue, the method of the invention may be employed at a temperature within the range of from +35 degrees Centigrade to about +45 degrees centigrade, for example, at +40, +41, +42, +43, +44 or +45 degrees Centigrade, for a period of from a few seconds, for example 30 seconds up to a few minutes, for example, 1, 2, 3, 4, 5, 6, 7, 8, 9, 10, 11, 12, 13, 14, or 15 minutes or more depending on plant tissue type and design. Naturally, the skilled addressee will appreciate that the heat shock temperature should be such that it does not deleteriously affect the general viability of the plant material that is subjected to a heat shock step.

In a further aspect, there is provided a method of harvesting plant cells or plant tissues under cover wherein the said plant cells or plant tissues are exposed with light as herein described from one or more artificial light sources.

Also included as an aspect of the present invention is harvested plant material or plant cells obtainable by a method according to the present invention and having altered levels of phytochemicals, typically elevated levels of phytochemicals when compared to plant material or plant cells that have not been exposed to light of wavelengths used in the method of the present invention.

‘Cover’ is to be understood as a general term and may be taken to mean a receptacle in which the plant material or plant cells may be placed, for example a closed container with a built-in light source therein, such as a refrigerator unit comprising an in-built light source that can be activated on demand for a predetermined time interval. Thus, for carrying out the method of the invention use can be made of cooling means, such as a conventional refrigerator comprising a light source capable of emitting blue light in the manner hereinbefore described. Alternatively, ‘under cover’ may be taken to mean a processing factory wherein harvested plant material is exposed to one or more light sources producing light of appropriate wavelength or wavelengths over a short period of time during the processing operation, such as canning, freezing plant material, or immediately prior to the cooking of foods for canning or for baby food manufacture e.g. purees and the like, and further processed foods such as soups, vegetable-based sauces and the like.

Thus as a further aspect of the invention there is provided a processed food obtainable by a food processing method by exposing live plant cells with light of wavelengths as herein described at light intensities as herein described. Suitable wavelengths of light are those described herein and these are applied for appropriate, predetermined time intervals as described herein. A still further aspect of the invention provides a food processing method comprising exposing live plant cells to light wavelengths as herein described from at least one artificial light source. Typically the wavelength(s) of the light is/are selected from wavelengths as herein described and is applied for a predetermined period of time sufficient to alter the phytochemical profile of the exposed plant cells and/or harvested plant tissue.

“Plant cells” also includes those plant parts or tissues which display an aromaticity which is detectable by the human olfactory senses when cut or harvested. Such plants may display the aromaticity naturally, for example in the case of cut herbs, from the cut leaves. The plant cells or tissue or parts include members of the Labiatae, such as the broad-leafed herbs. Suitable examples of broad-leafed herbs include basil, oregano, sage, coriander, dill, marjoram and thyme. Other herbs, such as cut herbs that may benefit from being treated according to the present invention include chives, garlic, bay leaf, lemon balm, mint, lavender, parsley, the fennels, e.g. bronze fennel and common fennel, and the like. A more complete list of common herbs to which the invention can be applied is to be found in Taylors Guide to Herbs 1995, Eds. Buchanan R. & Tenebaum F. Houghton Mifflin Co. New York: the teaching of this guide reference is hereby incorporated into the teaching of the present specification. Naturally, the skilled addressee will appreciate that the said plant cells or plant parts are alive when exposed to light in accordance with the present invention and are capable of responding to the application of the cold light-derived light stimulus.

Plant cells or plant parts may be harvested at any stage of growth so long as the harvested plant cells or tissue are capable of responding to the application of light of wavelength and duration as outlined herein. In a preferred embodiment, the harvested plant cells or tissue of broad-leaf herbs can be exposed to wavelengths of light used in the present invention from the 3 to 4 leaf stage and most preferably in the case of culinary herbs such as basil, the 5-leaf stage. It is envisaged that plant cells and/or tissue such as culinary herbs and green vegetables are most usefully exposed as herein-described immediately before processing (e.g. freeze drying, adding to processed foods such as sauces, soups, canned goods and the like), that is to say after the harvesting of cuttings from such plants and/or the provision of young plants for processing e.g. as dried herbs. Dried herbs treated with light as outlined herein immediately post-harvest, for a short period of time, particularly those measured at the 5-leaf stage, are considered to display an increased aromaticity relative to controls which are not exposed to light as described herein.

The artificial light source or sources can be of any suitable conventional type, such as a light emitting diode or even a white light source comprising filters that let through light of the desired wavelength(s). The light source may be placed at any distance from the harvested material provided that the light energy used is sufficient to influence, for example to induce or saturate oxygen evolution at the photosystem II reaction centre and/or to trigger, that is set off, a transient photo-oxidative stress and/or a moderate photosynthetic electron transport inhibition. Optimising of the light energy and light composition may be performed for example, by monitoring oxygen evolution and chlorophyll a fluorescence using conventional methods (e.g. according to the instruction manual and software of Hansatech Instruments Ltd., King's Lynn, UK). It is preferable to locate the light source in a position which affords the greatest amounts of irradiation per square unit (e.g. cm², m² etc.) of the harvested plant material. Suitably, depending on the size of the covered area, for example that of a processing compartment in a processing factory, or of a refrigerator or other container such as a microwave oven or magnetron fitted with a suitable light source capable of being manually or automatically activated, for example, by employing a timing means and thereby emitting wavelengths of light as indicated herein and described herein. Alternatively, an independent container specifically designed for exposing plant parts or cells to light of wavelengths as described herein may be employed. In a further alternative, the number of light sources may be as little as one to a whole ‘battery’ of light sources arranged in series and/or in parallel, for example, in a food processing factory setting, each light source being suitably distanced one from the other at appropriate intervals in such a manner as to effect exposure of the plant material to light of wavelengths as described herein which results in a significant alteration in the level of phytochemicals found therein, preferably an increase of desired phytochemicals.

In a further embodiment of the invention there is provided use of blue light from an artificial light source in a method of processing plant cells or harvested plant tissue under cover. Preferably, the blue light wavelength is selected from the wavelengths of light found as herein described. The blue light may be used in conjunction with other wavelengths of light as herein described.

In a further embodiment, there is provided use of at least blue light in a method as described herein for increasing the phytochemical content in harvested live plant material. In a preferment, the said plant material is located under cover.

In a further embodiment of the invention there is provided the use of plant parts exposed to blue light as described herein in the manufacture of human foodstuffs, such as frozen vegetables (e.g. spinach or plant parts from a Brassica species) or seeds (e.g. peas), bottled or canned condiments, for example sauces for meat, fish and poultry dishes, flavourings, for example tapenade, salad dressings, cooking oils such as olive oil, sunflower oil and the like, soups, pasta and cheeses.

As another application of the present invention, blue light or red light or a combination of red and blue light may be employed in a greenhouse setting on growing plants. In Northern Hemisphere countries such as Holland, the Scandinavian countries, Belgium, Germany and the UK many varieties of ornamental plants, greenhouse produced lettuce, tomatoes and other salad vegetables are grown under cover. The lighting is supplied in the form of yellow light, typically from sodium lamps. However, such lighting systems lose a lot of energy as heat and do not mimic the blue, red or red and blue spectra of natural sunlight. By modulating the light intensity of blue and/or red light that is shone onto plants, it is possible to optimise the growing phase of the plant and to improve seed set, plant habit, and yield. Thus plants can be produced which are in optimum health and have a full complement of phytochemicals as alluded to herein. In a still further embodiment of the invention there is provided use of blue light and/or red light in improving seed set of plants grown under cover in a greenhouse or in a hydroponics growing system. Furthermore there is provided as another aspect of the invention use of blue light and/or red light in optimising the plant habit of plants grown in the greenhouse or in a hydroponics system. Such uses provide for more efficient production of plants that are grown under cover in the greenhouse, such as ornamentals, salad plants such as lettuces, tomatoes, capsicums and the like.

According to a further aspect of the invention there is provided apparatus for performance of the method in accordance with any of the preceding aspects, the apparatus comprising an enclosure defining an exposure chamber, support means disposed in the chamber for supporting plant material therein in such a manner and position as to permit exposure to light from a plurality of directions, and light generating and applying means to generate blue light and to apply the generated light to the supported plant material for a predetermined period of time and from a plurality of directions to provide exposure of the material to the light from more than one side.

The enclosure preferably has the form of a housing of any suitable volumetric form, for example cuboidal, which is closed at some or all of its sides. Such a housing can range from a relatively small-size appliance of the kind compatible with domestic use, for example similar in concept to a microwave oven, through medium-size equipment suitable for use in commercial food preparation premises, for example a restaurant, to a large-size installation appropriate to bulk material treatment in an industrial context, such as a food-processing plant. In the case of larger size applications, the enclosure may take the form of a structure bounded by walls, base and ceiling representing integral or fitted internal elements of a building.

The exposure chamber defined by the enclosure can similarly be of any appropriate volume, subject only to the consideration that it should be large enough to accommodate light paths to the supported plant material in all the intended directions, but preferably not so large that the paths to the material are of such length that an undue expenditure of energy is necessary to ensure application of the requisite intensity of light.

The support means in a basic form thereof comprises a member, such as a shelf, forming a surface on which the plant material can be placed. The member in that case should be light-permeable, whether by construction from transparent material such as glass or clear plastics or by construction from intrinsically non-transparent or opaque material having light passage openings, for example a grating, mesh or apertured plate. Other forms of support means are equally possible depending on the kind of plant material, for example strips engageable under end portions of the material if of stable form, clamps or clips to fix and stretch or suspend the material, a pin or pins to support the material punctiformly or even skewer the material or a receptacle—whether transparent or perforated—to receive the material, particularly loose material. Numerous other forms of support means are possible provided the light can reach several sides of the material so that the material is exposed to the light over a sufficient proportion of its area.

Moreover, the support means can be stationary or mobile depending on whether the plant material is to reside in the chamber in a fixed location or to move through the chamber. In the case of movement of the material, the support means can be stationary and the enclosure itself, inclusive of the light generating and applying means, can be mobile so as to travel, perhaps in reciprocating manner, relative to the support means and in the supported material. In the case of mobile support means or a mobile enclosure, the enclosure may be formed with one or more openings defining an entrance and exit or a combined exit/entrance, the or each opening being optionally closable by a door or other closure means.

The light generating and applying means preferably comprises a plurality of light sources, a single light source with an appropriate number of suitably positioned reflectors or a plurality of light sources in conjunction with reflectors. The use of reflectors reduces energy costs at the expense of some attenuation of the light intensity, which may or may not be of consideration depending on the size of the exposure chamber and quantity of plant material to be treated. The number and disposition of the light source or light sources and reflectors is thus preferably selected in dependence on constructional parameters of the apparatus and also parameters of the particular method of treatment. In a small-size appliance, the light sources may, for convenience in the provision of the power supply, be mounted in the same general region, for example a ceiling of the chamber, and reflectors provided in the region of the base of the chamber. The light exit surfaces of the sources and the planes of reflective surfaces of the reflectors can be oriented to ensure that light of the selected wavelength or wavelengths is aimed directly at the top, bottom and sides of the supported plant material. Such light sources can be, as already mentioned, single lamps or arrays of lamps, for example incandescent bulbs or fluorescent tube-lights. The reflectors can be, for example, mirrors, polished metal panels or simply reflective coatings or coverings applied to appropriately oriented internal surfaces of the enclosure. Emission of light in the preferred wavelength ranges as described herein can be achieved by transmitting the light emitted by the or each source through a transmission filter passing on light only of a selected specific wavelength. Similarly the duration of application of the light to the supported plant material can be controlled by switching operating voltage of the light source or sources by way of timing means with a time selection facility. Control of duration of exposure to the light can, however, equally well be achieved by other optical measures including screening or shielding the plant material, screening or shielding the light source or sources and reflector or reflectors, and influencing selectably reflective surfaces to become light transmissive. Alternatively, the treated plant material can be removed from the exposure chamber at the conclusion of the predetermined time period, whether by ejection after a dwell time in a rest state or by departure from the chamber after travel therethrough for the predetermined period, such travel embracing both movement of the support means supporting the material and movement of the enclosure inclusive of light source or sources and any associated reflectors.

The light generating means can comprise a plurality of light sources for different forms of light, for example a blue light emitting source, such as one or more blue light emitting diodes (LEDs), and a white light emitting source, such as one or more conventional white light emitting diodes (LED). The light generating means may also comprise one or more red light emitting sources, such as, one or more red LEDs. Whether a single light source emitting wavelengths of light of selected wavelength is employed in an apparatus of the invention, or a plurality of light sources emitting a combination of light of different wavelengths is employed, will depend on the nature and purpose of the apparatus.

It is to be understood that the teaching of all references cited herein is incorporated into the instant specification.

### BRIEF DESCRIPTION OF THE DRAWING

The drawing is a schematic elevation of apparatus suitable for performing a method exemplifying the invention

### DETAILED DESCRIPTION OF THE INVENTION

The invention will now be described with reference to the following examples. It is to be understood that the examples are not to be viewed as limiting the scope of the invention in any way.

TABLE 1

| Plant leaf | Total asc | Averaged |
|---|---|---|
| Sample | umol/g FW | Total |
| 1.1 | 3.75 | |
| 1.2 | 3.34 | 3.63 |
| 1.3 | 3.78 | |
| 2.1 | 5.94 | |
| 2.2 | 5.89 | 6.07 |
| 2.3 | 6.36 | |
| 3.1 | 4.85 | |
| 3.2 | 4.63 | 4.52 |
| 3.3 | 4.08 | |
| 4.1 | 2.36 | |
| 4.2 | 1.89 | 2.11 |
| 4.3 | 2.08 | |
| 5.1 | 3.90 | |
| 5.2 | 3.53 | 3.55 |
| 5.3 | 3.22 | |
| 6.1 | 2.54 | |
| 6.2 | 3.16 | 2.95 |
| 6.3 | 3.16 | |

### Examples Section

### A. Broccoli

Control: samples 1.1-1.3 are broccoli florets from a supermarket. Vitamin C level was measured by assay (Foyer et al. (1983) Planta 157:239-44; Wise & Naylor (1987) Plant Physiol. 83:278-82; Yoshimura et al. (2000) Plant Physiol. 123:223-33) in samples prior to treatment with light.

Samples 2.1-2.3 are broccoli florets treated with i) white light enriched with blue light (light source distance from sample 50 cms) for a period of 4 hours (600 microE+/−50 of blue enriched white light from halogen lamps (Quartzline EHJ, 250 W, 24V light, obtained from General Electric) and ii) with additional 15 min pulses (15 min on; 15 min off; light source distance from sample 30 cms) of blue light alone (20 microE+/−3 generated by LEDs (333/2UBC/C340, GaN/SiC supplied by Everlight Electronics Co. Ltd. Taipai 236 Taiwan), applied over the same 4 hour period.

Vitamin C levels were measured using the same assay as employed in the control.

Samples 3.1-3.3 are broccoli florets treated only with white light enriched with blue light (light source distance from sample 50 cms) for a period of 4 hours (600 microE+/−50 of blue enriched white light from halogen lamps (Quartzline EHJ, 250 W, 24V light, obtained from General Electric).

Results are shown in Table 1.

### B. Rocket

Control: samples 4.1-4.3 are samples of rocket lettuce from a supermarket. Vitamin C level was measured by assay Foyer et al. (1983) Planta 157:239-44; Wise & Naylor (1987) Plant Physiol. 83:278-82; Yoshimura et al. (2000) Plant Physiol. 123:223-33) in samples prior to treatment with light.

Samples 5.1-5.3 are rocket lettuce leaves treated with i) white light enriched with blue light (light source distance from sample 50 cms) for a period of 4 hours (600 microE+/−50 of blue enriched white light from halogen lamps as described for the broccoli example above) and ii) with additional 15 min pulses (15 min on; 15 min off; light source distance from sample 30 cms) of blue light alone (50 microE+/−5 generated by LEDs as used in the broccoli example above) applied over the same 4 hour period.

Vitamin C levels were measured using the same assay as employed in the control.

Samples 6.1-6.3 are rocket lettuce leaves treated only with white light enriched with blue light (light source distance from sample 50 cms) for a period of 4 hours (600 microE+/−50 of blue enriched white light from halogen lamps as described above).

Vitamin C levels were measured using the same assay as employed in the control.

Results are shown in Table 1.

### C. Peas

Peas were treated as described for the broccoli and rocket samples provided above. Alterations in the levels of vitamin C are observed.

D. Green cabbage

Green cabbage obtained from a supermarket was treated as described for the broccoli and rocket samples provided above. Alterations in the levels of vitamin C are observed.

E. Green beans

Green beans obtained from a supermarket were treated as described for the broccoli and rocket samples provided above. Alterations in the levels of vitamin C are observed.

F. Snow peas

Snow peas (mange tout) obtained from a supermarket were treated as described for the broccoli and rocket samples provided above. Alterations in the levels of vitamin C are observed.

### Amelioration of Nutritional Value of Harvested Vegetables by Application of Red and Blue Light at Chilling Temperatures.

Here is presented a method illustrating some appropriate light treatments of harvested plant parts that can be used for the storage of harvested fresh plant produce in domestic refrigerators or in commercial refrigeration and further storage areas.

### Material and Methods

Broccoli, French salad (roman) lettuce, snow peas and green peppers (capsicum) were obtained from a local supermarket.

Plant material was placed in a refrigerator in the dark (0°-1° Centigrade at 80% relative humidity) for a period of 10 days.

During this period, the plant material was exposed to combined blue and red light using a custom-built light display as described in co-pending British patent application GB06 23 636.8, the teaching of which is incorporated herein, that comprises 12 red-light diodes and 12 blue-light diodes, ‘Lumiled’ LXHL-LD3C (Trade Mark) diodes and ‘Lumiled’ LXHL-LR3c (Trade Mark) diodes, respectively. The plant parts were exposed to the combined blue and red light conditions for 2.5 hours per day over the 10 day period in the following light combination at the given light intensities: blue (B) 5 microE×s⁻¹m⁻²(0.5 W) and red (R) light 10 microE×s⁻¹ m⁻²(1.0 W) at 0° Centigrade. The distance of the light source from the shelf was 35 cms.

Samples for vitamin and sweetness analysis were taken at the start of the experiment, T_{O} and after the second, fourth, and eighth days of exposure to the above light, temperature and humidity conditions. Control plant material was kept in the same refrigerator, but in the dark.

### Sweetness

Sweetness was measured with a pocket refractometer according to the manufacturer's instruction pamphlet (PAL-3 Pocket Refractometer, ATAGO®, Tokyo, Japan). Samples for measurement were taken just before each exposure to the red:blue light combination at each instance.

### Vitamin C

Vitamin C (ascorbate) (Foyer et al. (1983) Planta 157:239-44; Wise & Naylor (1987) Plant Physiol. 83:278-82; Yoshimura et al. (2000) Plant Physiol. 123:223-33) level was measured by assay in all samples using methodologies described in the art.

### Results and Discussion

### General Condition of Plants During Experiment

During the first few days (less than 4 days) of exposure of plant material to the above conditions significant differences in senescence and loss of fresh weight and freshness of plant material in comparison to control plant material kept in the dark were not observed. However, after 4 days and thereafter, differences became apparent. Exposed plant material, that is to say, test plant material, was generally in a better condition than control plant material. Senescence and decomposition symptoms of control plant material were observed after 7 days, while test plant material remained in good or very good condition. Moreover after one week test plant material had a pleasant odour, while control plant material produced the characteristic but not intensive odour of senescence and decomposition. During the 7 day period differences became obvious. These observations are in agreement with the data presented in Tables 1 and 2 (below).

### Sweetness

Sweetness (measured as Brix index) of all analysed plants increased after exposure to combined red and blue light at 0° Centigrade as described below (Table 1) in comparison to control plants kept at 0° Centigrade. Increased levels of sugars were due to the switching on of photosynthetic activity in test plants. It is well known that photosynthesis converts CO₂ and H₂O into sugars and chemical energy that is stored in the form of adenosine triphosphate (ATP). Decreased levels of sugars observed in plant material stored in the dark correlates with accelerated senescence and decomposition of plant material, which is associated with increased respiratory processes (metabolizing of sugars and lipids into chemical energy).

TABLE 1
Sweetness (Brix) of lettuce, broccoli, pea and green pepper.
Samples were taken at different time points (T₀, 2-days, 4-days
and 8-days) after combined red and blue light treatment.

| | Brix | Brix | Brix | Brix |
|---|---|---|---|---|
| Plant | per cent | per cent | per cent | per cent |
| Sample | T₀ | 2 days | 4 days | 8 days. |
| lettuce | | | | |
| With light | 2.48 | 3.37 | 4.11 | 4.75 |
| Without light | 2.61 | 2.42 | 2.05 | 0.97 |
| Broccoli | | | | |
| With light | 5.19 | 6.07 | 7.43 | 8.84 |
| Without light | 5.27 | 4.93 | 4.13 | 3.02 |
| Snow pea | | | | |
| With light | 8.72 | 9.31 | 10.55 | 11.33 |
| Without light | 8.21 | 7.38 | 7.11 | 6.14 |
| Green pepper | | | | |
| With light | 5.72 | 6.67 | 7.55 | 8.37 |
| Without light | 5.98 | 4.85 | 4.14 | 3.72 |

### Vitamin C

Changes in sweetness level were accompanied by an increase in ascorbate levels (Table 2).

The increase in vitamin C content was observed in plant material exposed to combined blue and red light. Taken together, the presented results indicate that combined blue and red light treatment gives optimal results in terms of increased sweetness and vitamin C content.

It is presented here that treatment with red and blue light of harvested plant material is able to increase levels of vitamins and sugars and prevent senescence in plants stored in refrigerators.

TABLE 2
Vitamin C content (μmol per g of fresh weight) of lettuce, broccoli,
snow pea and green pepper. Samples were taken at different time points
(T₀, 2-days, 4-days and 8-days) after combination of red and
blue light treatment.

| | Total Vit C | Total Vit C | Total Vit C | Total Vit C |
|---|---|---|---|---|
| Plant | FW | FW | FW | FW |
| Sample | T₀ | 2 days | 4 days | 8 days |
| lettuce | | | | |
| With light | 0.26 | 0.31 | 0.38 | 0.43 |
| Without light | 0.28 | 0.21 | 0.18 | 0.11 |
| Broccoli | | | | |
| With light | 3.21 | 3.59 | 4.17 | 4.36 |
| Without light | 3.17 | 2.89 | 2.77 | 2.51 |
| Snow pea | | | | |
| With light | 1.63 | 1.92 | 2.12 | 2.81 |
| Without light | 1.55 | 1.32 | 1.14 | 0.81 |
| Green pepper | | | | |
| With light | 2.11 | 2.24 | 2.71 | 3.14 |
| Without light | 2.18 | 2.12 | 1.98 | 1.37 |

### Rapid Amelioration of Nutritional Value of Harvested Vegetables by Application of High Intensity of Blue and Red Light at Room Temperatures.

### Introduction

Here is presented a method illustrating some appropriate light treatments of harvested plant parts that can be used for rapid amelioration of nutritional values of harvested fresh plant produce directly prior consumption.

### Material and Methods

Broccoli, pepper (capsicum), and cabbage were obtained from a local supermarket.

The plant material was firstly submerged in water in a glass mixing bowl and directly exposed to high intensity of combined red and blue light for periods of up to 45 minutes.

Green plant material was exposed to the above light conditions for up to 45 minutes in the following light combination: red (R) 340 microE (34.0 W) and blue (B) light 200 microE×s⁻¹ m⁻²(20 W) at 20 degrees Centigrade.

Samples for vitamin and sweetness analysis were taken at start (T₀) of the experiment and after 15 (T₁₅), 30 (T₃₀) and 45 (T₄₅) minutes of exposure to the given light conditions and temperature. Control plants were kept in the dark and samples for vitamin and sweetness analysis were taken at T₀ and T₄₅.

### Sweetness

Sweetness was measured with a pocket refractometer according to the manufacturer's instruction pamphlet (PAL-3 Pocket Refractometer, ATAGO®, Tokyo, Japan).

### Vitamin C

Vitamin C (ascorbate) (Foyer et al. (1983) Planta 157:239-44; Wise & Naylor (1987) Plant Physiol. 83:278-82; Yoshimura et al. (2000) Plant Physiol. 123:223-33) level was measured by assay in all samples using methodologies described in the art.

### Results and Discussion

### Sweetness

Sweetness (measured as Brix index) of all analysed plant material increased after exposure to combined red and blue light in 20 degrees Centigrade as described below (Table 1) in comparison to unexposed plant material kept in the dark. Increased levels of sugars were due to increased photosynthetic activity in light-exposed plant material. It is well known that photosynthesis converts CO₂ and H₂O into sugars and chemical energy stored in the form of adenosine triphosphate (ATP).

TABLE 1
Sweetness (Brix) of broccoli, cabbage and green pepper. Samples
were taken at different time points (T₀, 15 (T₁₅), 30 (T₃₀) and
45 min (T₄₅)) after treatment with the combination of red and blue
light as described herein.

| | Brix | Brix | Brix | Brix |
|---|---|---|---|---|
| Plant | per cent | per cent | per cent | per cent |
| Sample | T₀ | T₁₅ | T₃₀ | T₄₅ |
| Broccoli | | | | |
| With light | 3.98 | 4.15 | 4.34 | 4.58 |
| Without light | 3.96 | nd | nd | 3.91 |
| Cabbage | | | | |
| With light | 4.27 | 4.47 | 4.55 | 4.78 |
| Without light | 4.30 | nd | nd | 4.23 |
| Green pepper | | | | |
| With light | 5.41 | 5.69 | 5.88 | 6.09 |
| Without light | 5.43 | nd | nd | 5.37 |

### Vitamin C

Changes in sweetness level were accompanied by an increase in ascorbate levels (Table 2).

The increase in vit C content was observed in plant material exposed to a combination of blue and red light (see Table 2). Taken together, the presented results indicate that the combination of high intensity blue and red light treatment gives optimal results in terms of rapidly increased sweetness and vit C content.

It is presented here that treatment with red and blue light of harvested plants parts is able to rapidly increase levels of vitamins and sugars just prior to consumption.

TABLE 2
Vitamin C content (μmol per g of fresh weight) of broccoli, cabbage
and green pepper. Samples were taken at different time points (T₀,
15 (T₁₅), 30 (T₃₀) and 45 min (T₄₅)), after being treated with a
combination of red and blue light.

| | Total Vit C | Total Vit C | Total Vit C | Total Vit C |
|---|---|---|---|---|
| Plant | μmol/g FW | μmol/g FW | μmol/g FW | μmol/g FW |
| Sample | T₀ | T₁₅ | T₃₀ | T₄₅ |
| Broccoli | | | | |
| With light | 3.47 | 3.74 | 3.91 | 4.13 |
| Without light | 3.53 | nd | nd | 3.51 |
| Cabbage | | | | |
| With light | 2.83 | 3.12 | 3.37 | 3.81 |
| Without light | 2.85 | nd | nd | 2.81 |
| Green pepper | | | | |
| With light | 2.34 | 2.64 | 2.95 | 3.11 |
| Without light | 2.37 | nd | nd | 2.33 |

Referring now to the accompanying drawings, there is shown a schematic elevation of apparatus 10 suitable for performance of a method exemplifying the invention. The apparatus 10 has the form, by way of an example only, of a domestic appliance suitable for kitchen use and comprises a housing 11 of generally cuboidal form with permanently closed ceiling, base and three walls, the fourth wall (not shown) functioning as a door affording access to the interior of the housing.

The housing bounds an exposure chamber which has, in an approximately central position a glass plate 12 serving as a support for plant material 13 to be exposed to treatment light in the chamber. Such light is generated by three mutually separate light sources 14 disposed in the upper region of the chamber and having light exit surfaces 15 oriented to direct light generally towards the top of the plate 12 and thus the upper surface of plant material supported thereon and generally laterally of the plate towards the base of the chamber. Disposed in the vicinity of the base and in such positions as to intercept the laterally directed light are reflectors 16 in the form of mirrors angled so that incident light is directed towards the underside of the plate 12 and thus the lower surface of the plant material, the lower surface being exposed to the light by virtue of the transparency of the plate. The illustrated location of the reflectors 16 and associated reflected light beams is merely by way of example and further such reflectors may be provided to reflect beams obliquely forwardly and backwardly with respect to the plane of the drawing. The material 13 supported on the plate 12 is thus exposed to light at both its upper and lower surface and, to varying degrees, at its side surfaces. Such a disposition of light sources and reflectors has been found to provide a compromise between effective exposure of supported plant material to the generated light and a simple construction with economic operating costs.

The light sources include transmission filters to pass on only light of a selected wavelength or selected wavelengths in the range of 400 to 700 mm and are so controlled by a programmable timer 17 in power feeds 18 to the sources as to emit light for a period of time predetermined to be sufficient to achieve the desired transient alteration in the cell or tissue phytochemicals of the treated plant material.

The appliance is thus conveniently usable for performance of the treatment method immediately prior to cooking or consumption of the treated material.

1. A method of altering the level of at least one phytochemical in a harvested plant cell or in harvested plant tissue comprising:
providing one of a harvested plant cell comprising chlorophyll and a harvested plant tissue comprising chlorophyll, the provided cell or tissue being capable of photosynthesis;
setting an ambient temperature of the provided cell or tissue to a temperature in the range of −0.5 degrees centigrade to 18 degrees centigrade;
exposing a surface of the provided cell or tissue for irradiation by light;
irradiating the exposed surface by shining blue light from an artificial source thereof onto the exposed surface while maintaining the set ambient temperature; and
setting the intensity of the said light striking the exposed surface so as to influence oxygen evolution at the photosystem II reaction centre of the provided cell or tissue and thereby initiate in the cell or tissue a biochemical process causing alteration of the level of said at least one phytochemical in the cell or tissue.

2. A method according to claim 1, wherein the light intensity of blue light striking the harvested plant cell of plant tissue lies in the range of from 5 microEinsteins+/−3 microEinsteins to 400 microEinsteins+/−50 microEinsteins per second per square meter.

3. A method according to claim 1, wherein irradiating the exposed surface further comprises shining red light from an artificial source thereof onto the exposed surface so that the light striking the exposed surface is blue light and red light.

4. A method according to claim 3, wherein the combined light intensity from the blue and red light sources striking the plant cell or plant tissue lies in the range of from 15 microEinsteins+/−5 microEinsteins to 300 microEinsteins+/−50 microEinsteins per second per square meter.

5. A method according to claim 4, wherein the said light intensity is 40 microEinsteins+/−10 microEinsteins per second per square meter.

6. A method according to claim 1, wherein the blue light wavelength lies in the range of from 420 nm-490 nm.

7. A method according to 4, wherein the red light is of a wavelength that lies in the range of from 600 nm-700 nm.

8. A method according to claim 4, wherein the energy ratio of blue light:red light lies in the range of from 7:1 to 1:7

9. A method according to claim 1, wherein the ambient temperature lies in the range of from 1° Centigrade to 16° Centigrade.

10. A method according to claim 1, wherein the ambient temperature lies in the range of from 1° Centigrade to 12° Centigrade.

11. A method according to claim 1, wherein the method is performed at a relative humidity lying in the range of from 60% to 100% RH.

12. A method according to claim 1, wherein the irradiation is carried out for a predetermined time interval.

13. A method according to claim 12, wherein the said time interval is selected from a pulsed or a continuous time interval.

14. A method according to claim 12, wherein the said time interval is pulsed at a predetermined frequency that is spread over a time period that is longer in duration than the said pulsed time interval.

15. A method according to claim 14, wherein the said time period is up to 96 hours.

16. A method according to claim 13, wherein the said time interval is a pulsed time interval and lies in the range of from 1 second to 120 minutes for each time pulse.

17. A method according to claim 12, wherein the said time interval lies in the range of from 1 minute to 60 minutes.

18. A method according to claim 1, wherein the harvested plant cell or plant tissue is selected from plant tissue capable of photosynthesis that is selected from green stems, calyx and leaves of higher order plants, algal cells, moss protonema and cell cultures of edible and/or inedible or unpalatable higher and lower plant species, wherein the harvested plant cell or plant tissue is obtained from a plant selected from the group comprising herbs, Catharanthus roseus, plants of the family Taxaceae, Cannabis plants, green vegetables and green seeds, wherein the plant is selected from the group comprising peas, green beans, spinach, snowpeas (mange tout), species from the Brassica oleracea that includes broccoli, green cabbage, red cabbage, Brussels sprouts, kohlrabi, cauliflower and white cabbage, lettuce, Chinese cabbage, moss tissue including protonema of Physcomitrella patens, cultures of lemnaspora species, algal cell cultures, somatic embryo clusters and fruits.

19. A method according claim 1, wherein the at least one phytochemical is selected from antioxidants.

20. A method according to claim 1, wherein the at least one phytochemical is selected from Vitamin C and Vitamin E.

21. Cooling apparatus for performance of the method according to claim 1, comprising
an enclosure defining a cooling chamber,
support means disposed in the cooling chamber for supporting harvested plant material therein to permit exposure of a surface thereof to light, the plant material being capable of photosynthesis,
means for setting an ambient temperature in the cooling chamber to a value in the range −0.5 degrees Centigrade to 18 degrees Centigrade, and
an artificial light source for emitting blue light and for shining the emitted light onto the exposed surface of plant material supported on the support means in the chamber while at the said ambient temperature, the artificial light source being operable to emit blue light of an intensity set at the exposed surface of the plant material to influence oxygen evolution at the photosystem II reaction centre of the plant material and thereby initiate in the plant material a biochemical process causing alteration of the level of said at least one phytochemical in that material.

22. Apparatus according to claim 21, wherein the support means is disposed so that the light can reach several sides of the plant material for exposure thereof to the light over a predetermined minimum proportion of its area.

23. Apparatus according to claim 21, wherein the support means comprises a member having a surface on which the material can be placed.

24. Apparatus according to claim 23, wherein the light-permeable member comprises one of a material permeable to light and a construction permeable to light.

25. Apparatus according to claim 21, wherein the light source comprises a plurality of light emitters to emit light in different directions.

26. Apparatus according to claim 21, wherein the light source comprises a single light emitter and a plurality of reflectors to reflect light from the emitter in different directions.

27. Apparatus according to claim 21, wherein the light source comprises a plurality of light emitters and a plurality of reflectors to emit light and reflect light, respectively, in different directions.

28. Apparatus according to claim 21, wherein the light source comprises at least one light-emitting diode.

29. Apparatus as claimed in claim 21, wherein the light source is further operable to emit red light.

30. Apparatus as claimed in claim 21, wherein the apparatus is a refrigerator.
